(19) United States
(12) Patent Application Publication
(10) Pub. No.: US 2020/0285966 A1
(43) Pub. Date: Sep. 10, 2020

(54) ESTIMATION APPARATUS AND ESTIMATION METHOD

(71) Applicant: FUJITSU LIMITED, Kawasaki-shi (JP)

(72) Inventors: Yuichi Ike, Kawasaki (JP); Takuya Takagi, Kawasaki (JP)

(73) Assignee: FUJITSU LIMITED, Kawasaki-shi (JP)

(21) Appl. No.: 16/807,556

(22) Filed: Mar. 3, 2020

(30) Foreign Application Priority Data
Mar. 6, 2019 (JP) 2019-040528

(51) Int. Cl. G06N 5/02; G06F 17/18

(52) U.S. Cl. CPC G06N 5/02; G06F 17/18

(57) ABSTRACT

A program causes the processor to: estimate, a determination result of a model for performing determination based on attribute values corresponding to attributes related to a target, a degree of correlation of each of combination patterns with the determination result, each combination pattern being a combination that includes attributes selected from attributes satisfying a predetermined condition among the attributes and attributes selected from attributes other than the attributes satisfying the predetermined condition among the attributes, and estimate, based on a difference between a first degree of correlation of a first combination pattern among the combination patterns with the determination result, and a second degree of correlation of a second combination pattern that is a combination pattern obtained by removing a first attribute among the attributes satisfying the predetermined condition from the first combination pattern with the determination result, a degree of influence of the first attribute on the determination result.

### CROSS-REFERENCE TO RELATED APPLICATION

This application is based upon and claims the benefit of priority of the prior Japanese Patent Application No. 2019-40528, filed on Mar. 6, 2019, the entire contents of which are incorporated herein by reference.

### FIELD

The embodiment discussed herein is related to an estimation apparatus and an estimation method.

### BACKGROUND

There is a technique in which, for an attribute of data, a degree of correlation of the attribute with a label is estimated. For example, for an attribute, a p value simply representing whether or not the attribute is correlated with a label is calculated, and an attribute to be protected is ranked. It is also conceivable to consider degrees of correlation of all combinations of the attribute and each of other attributes.

For example, there is a technique for predicting an effect of the data attribute on a result of the label by changing the attribute of data.

Examples of the related art include James Wexler, “The What-If Tool: Code-Free Probing of Machine Learning Models”, Google AI Blog, Sep. 11, 2018, website: https://ai.googleblog.com/2018/09/the-what-if-tool-code-free-probing-of.html.

### SUMMARY

According to an aspect of the embodiments, a non-transitory computer-readable recording medium includes a program which, when executed by a processor, cause the processor to: estimate, with respect to a determination result of a determination model for performing determination based on a plurality of attribute values corresponding to a plurality of attributes related to a target, a degree of correlation of each of a plurality of combination patterns with the determination result, each combination pattern being a combination that includes one or more attributes selected from attributes satisfying a predetermined condition among the plurality of attributes and none or one or more attributes selected from attributes other than the attributes satisfying the predetermined condition among the plurality of attributes, and estimate, based on a difference between a first degree of correlation of a first combination pattern among the plurality of combination patterns with the determination result and a second degree of correlation of a second combination pattern that is a combination pattern obtained by removing a first attribute among the attributes satisfying the predetermined condition from the first combination pattern with the determination result, a degree of influence of the first attribute on the determination result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a table in a case where it is desired to determine that a degree of influence of sex is high in a result of acceptance and rejection;

FIG. 2 is a diagram illustrating a example of a table in a case where it is desired to determine that a degree of influence of nationality is high in a result of acceptance and rejection;

FIG. 3 is a diagram illustrating an example of a case where combinations of attributes are examined in a hierarchy;

FIG. 4 is a diagram illustrating an example of a case where combinations of attributes are examined in a hierarchy;

FIG. 5 is a block diagram schematically illustrating a configuration of an estimation apparatus according to the embodiment;

FIG. 6 is a diagram illustrating an example of a hierarchical structure representing a combination pattern of determination attributes;

FIG. 7 is a diagram illustrating an example of a case where a node influence degree is obtained for each node of a hierarchical structure;

FIG. 8 is a diagram illustrating an example of a method for calculating an influence degree of a determination attribute in a combination pattern;

FIG. 9 is a diagram illustrating an example of an input/output image of an estimation apparatus;

FIG. 10 is a block diagram schematically illustrating a configuration of a computer functioning as an estimation apparatus; and

FIG. 11 is a flowchart illustrating an example of processing performed by the estimation apparatus.

### DESCRIPTION OF EMBODIMENTS

For example, for one attribute of the background art, when the correlation of combinations with all other attributes is simply taken into consideration, it may not be possible to consider influence due to partial combinations, influence from other attributes, and the like.

There is a problem that it is difficult to rank the attribute with grasping the correlation of the combination of attributes and considering the influence of other attributes.

Hereinafter, an example of the embodiment will be described in detail with reference to the drawings.

The premise of the embodiment is described below.

In the embodiment, it is assumed that the degree of influence of an attribute on the label is to be ranked. In the embodiment, for convenience of description, an attribute to be noticed as a target to be ranked is referred to as “determination attribute”, an attribute not to be noticed as a target to be ranked is referred to as “non-determination attribute”, and an attribute in a case of not being distinguished is simply referred to as “attribute”. The determination attribute is an example of an attribute satisfying a predetermined condition. The non-determination attribute is an example of an attribute other than an attribute satisfying a predetermined condition. The label is an example of a determination result of a determination model for performing determination based on a plurality of attribute values corresponding to a plurality of attributes related to a target. Specific examples of the label will be described later.

As described in the above problem, it is not possible to correctly determine whether or not the degree of influence on the label is derived from the determination attribute, by simply obtaining the correlation of all the combinations of attributes. More specifically, it is not possible to consider the correlation of a case where the determination attribute and the non-determination attribute are combined and the correlation of the non-determination attribute itself.

In view of this problem, in the embodiment, the degree of influence of the determination attribute is ranked using, as an index, the degree of correlation of the combination pattern excluding the determination attribute to be ranked, in consideration of an inclusion relation of the combination of attributes, that is, a hierarchical structure of the combination of attributes. By ranking in this manner, it becomes possible to rank the determination attribute, without being affected by the influence of the correlation of the non-determination attribute itself, in consideration of the influence of the combination of attributes.

For the determination attribute, it is desired to rank in an order of an influence degree that the determination attribute itself affects the label. This is because the determination attribute itself is considered to be a case where it is desired to determine how much influence affects the label. For example, if the label is a result of a test, it is desired to check whether or not the attribute has affected the results of the test. When the label is a result of purchase, it is desired to check which attribute affects the purchase in a market.

A case where the label is an acceptance and rejection result of an employment test will be examined below. The acceptance and rejection result of the employment test is a result of determining acceptance and rejection {0, 1} based on a score of the employment test performed to a person who desires employment. If the label is the acceptance and rejection result of the employment test, the attribute is, for example, a sex, a nationality, a field, a school, a Test of English for International Communication (TOEIC) score, or the like. The acceptance and rejection result is determined by attribute values of a plurality of attributes.

It is assumed that it is desired to check whether or not there is a discrimination in the acceptance and rejection of the employment test. In a context of such a discrimination, among the attributes, “sex” and “nationality” are attributes which are not desired to affect the acceptance and rejection. That is, since it is desired to examine the influence of the attribute, which is not desired to affect the acceptance and rejection, on the acceptance and rejection result, the “sex” and the “nationality” are the determination attributes. “field” is an attribute that may affect the acceptance and rejection. The attribute that may affect the acceptance and rejection may not be examined, and therefore, it is a non-determination attribute.

In this way, in the context of the discrimination in the employment test, the attribute to be protected (such as sex and nationality) and other attributes are divided into a determination attribute and a non-determination attribute. In this example, the attribute that is not desired to affect the label is regarded as the determination attribute, but the embodiment is not limited to such a case. For example, in the context of a market, a determination attribute and a non-determination attribute may be divided depending on contents to be examined, such as dividing a determination attribute and a non-determination attribute, as an adjustable attribute and a fixed attribute other than the adjustable attribute.

The combination of the determination attribute and the non-determination attribute is assumed to have two situations with respect to the influence of the attribute. There are (1) a situation where it is determined that a combination of a determination attribute and a non-determination attribute highly affects a label and (2) a situation where it is determined that a combination of a determination attribute and a non-determination attribute does not affect the label. The following description will be made by taking a case of the employment test as an example.

The situation of (1) is a situation in which there is no correlation of the determination attribute itself with the acceptance and rejection, but there is correlation in a combination of the determination attribute and the non-determination attribute, and there is no correlation in the non-determination attribute alone.

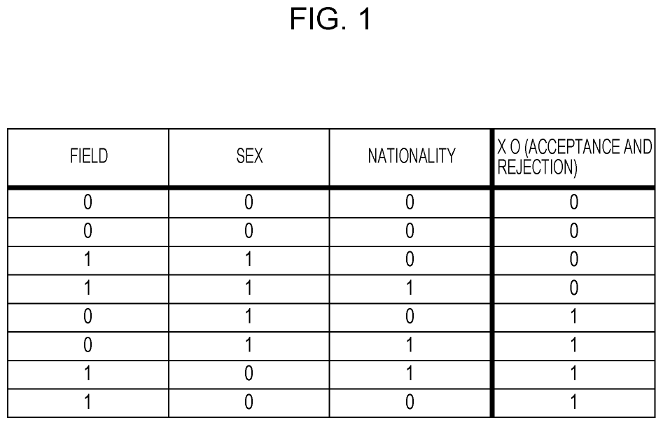

FIG. 1 is a diagram illustrating an example of a table in a case where it is desired to determine that a degree of influence of sex is high in a result of acceptance and rejection. In FIG. 1, the attributes of “field”, “sex”, and “nationality” are represented by a value of 0 or 1, and similarly, the label “XO (acceptance and rejection)” is represented by a value of 0 or 1. Hereinafter, the same applies to the drawings using the table. For example, when the attribute is regarded as an attribute alone, all of the values of the attributes are 0, and when all of the values of the labels are 1, the correlation is 1, which is a positive correlation. It may be said that the closer to 1 the value is, the higher the correlation is. Conversely, when the values of the attributes are 0 and 1 and all the labels are 1, the correlation is 0, and it may be said that there is no correlation.

The situation of (1) will now be described with reference to the example of FIG. 1. As illustrated in FIG. 1, there is no correlation of the determination attribute “sex” with the result of the acceptance and rejection. There is a slight correlation of the determination attribute “nationality” with the result of the acceptance and rejection. In this way, when it is considered only by the determination attribute alone, it is also grasped that the determination attribute “nationality” affects. However, the combination of the determination attribute “sex” and the non-determination attribute “field” has a high correlation with the result of the acceptance and rejection. The combination of the determination attribute “nationality” and the non-determination attribute “field” does not have a highly correlation. In this case, when it is considered from the non-determination attribute “field”, it is grasped that the determination attribute “sex” highly affects the result of the acceptance and rejection. The non-determination attribute “field” itself does not correlate with the result of the acceptance and rejection. Therefore, it is desired to determine that the degree of influence of the “sex” is higher than that of the “nationality”.

In the situation (1) above, if only the correlation of the attribute alone is extracted, it is determined that the degree of influence of the “nationality” is higher than that of the “sex”. That is, there is a problem that the degree of influence on the label may not be correctly calculated only by the correlation of the attribute alone.

In the situation (2), there is no correlation of the determination attribute itself with the acceptance and rejection, but there is correlation in a combination of the determination attribute and the non-determination attribute, and there is correlation in the non-determination attribute alone.

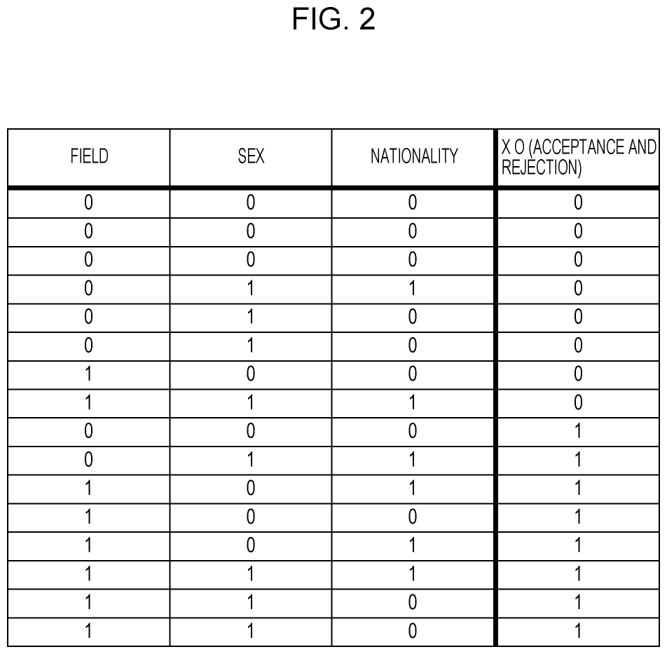

FIG. 2 is a diagram illustrating an example of a table in a case where it is desired to determine that a degree of influence of nationality is high in a result of acceptance and rejection.

The situation of (2) will now be described with reference to the example of FIG. 2. As illustrated in FIG. 2, there is no correlation of the determination attribute “sex” with the result of the acceptance and rejection. There is a slight correlation of the determination attribute “nationality” with the result of the acceptance and rejection. The combination of the determination attribute “sex” and the non-determination attribute “field” has a high correlation with the result of the acceptance and rejection. The combination of the determination attribute “nationality” and the non-determination attribute “field” has a slight correlation with the result of the acceptance and rejection. That is, it is grasped that the correlation of the non-determination attribute “field” is large, and that the “field” itself has a strong influence on the result of the acceptance and rejection. Conversely, it is grasped that the influence of the combination itself of the determination attribute “sex” and the non-determination attribute “field” that affects the result of the acceptance and rejection is small. Therefore, the influence of the combination is excluded, and it is determined that the degree of influence of the “nationality” is higher than that of the “sex”.

In the situation (2), when the correlation of the combination of the determination attribute and the non-determination attribute is taken out as it is and reflected in the degree of the influence of the determination attribute, it is determined that the degree of influence of the “sex” is higher than that of the “nationality”. That is, there is a problem that the degree of influence on the label may not be correctly calculated by merely considering the correlation of the combination.

In order to solve the problems of the above (1) and (2) situations, it is desirable to correctly reflect an origin of the attribute which affects.

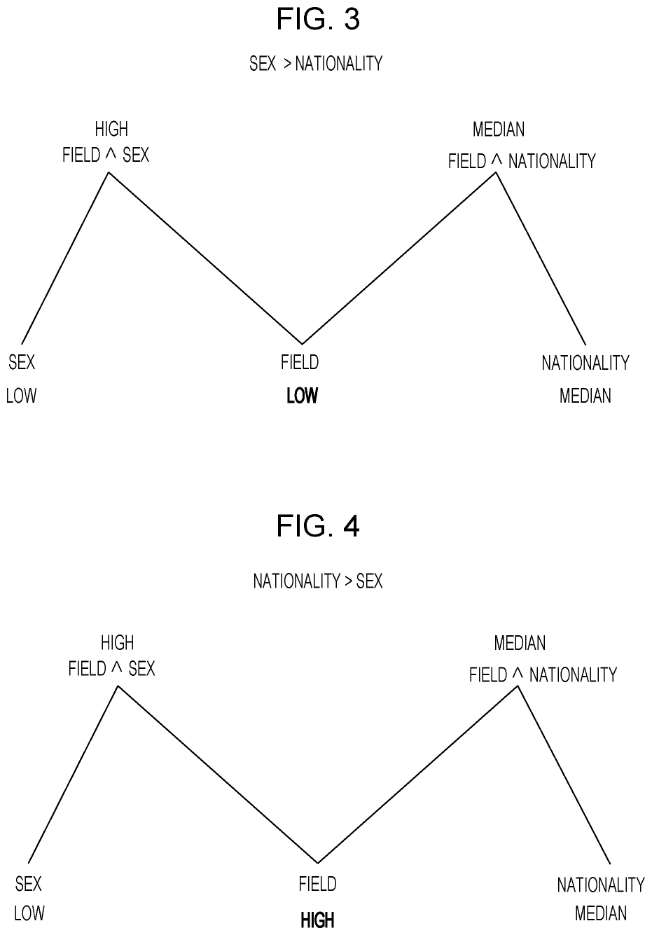

Therefore, in the embodiment, it is possible to consider the attribute inclusion relation, that is, the hierarchical structure of the attribute combinations. FIGS. 3 and 4 are diagrams illustrating an example of a case where combinations of attributes are examined in a hierarchy. FIG. 3 illustrates a situation in which the degree of influence of (1) is a sex>nationality, and FIG. 4 illustrates a situation in which the degree of influence in (2) is a nationality>sex. In FIGS. 3 and 4, only the degree of correlation of the non-determination attribute “field” is different from each other, and in FIG. 3, the degree of correlation is low, and in FIG. 4, the degree of correlation is high. In this way, the consideration is different depending on the degree of correlation of the non-determination attribute “field”.

Therefore, in the method according to the embodiment, the attribute is ranked using a hierarchical structure in which the correlation of the combination is grasped and the influence of the non-determination attribute may be taken into consideration.

Hereinafter, an example of a configuration of the embodiment will now be described in detail with reference to the accompanying drawings.

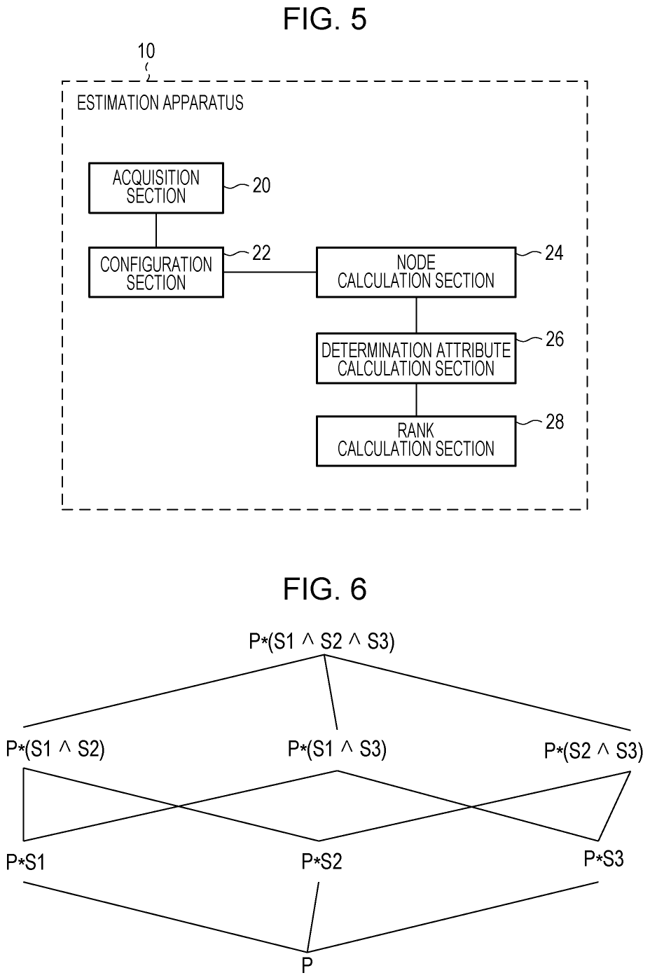

FIG. 5 is a block diagram schematically illustrating a configuration of an estimation apparatus 10 according to the embodiment. As illustrated in FIG. 5, the estimation apparatus 10 according to the embodiment is configured to include an acquisition section 20, a configuration section 22, a node calculation section 24, a determination attribute calculation section 26, and a rank calculation section 28. The node calculation section 24 is an example of a first estimation section, and the determination attribute calculation section 26 is an example of a second estimation section.

The acquisition section 20 acquires data including the attribute and the label as data to be analyzed, the determination attribute as a target among data, and an influence degree function used for the calculation of the node calculation section 24. The influence degree function will be described later. The determination attribute is set to one or more determination attributes selected with an operation by a user who operates the estimation apparatus 10.

The configuration section 22 constitutes, as a hierarchical structure of a plurality of combination patterns including a combination of determination attributes, a hierarchical structure in which assuming that the combination pattern is a node, an edge coupling each node to each other has an inclusion relation of a combination of determination attributes. FIG. 6 is a diagram illustrating an example of a hierarchical structure representing a combination pattern of determination attributes. In FIG. 6, the determination attribute is represented by S1 to S3, and an aggregation of non-determination attributes is represented by P. For example, when the non-determination attributes are R1 and R2, P={0, R1, R2, R1∧R2} and a node P*S3 has a combination pattern of P*S3 ={S3, R1∧S3, R2∧S3, R1∧S3}. Nodes other than P constitute a determination attribute and a combination pattern by a set of a determination attribute and a non-determination attribute.

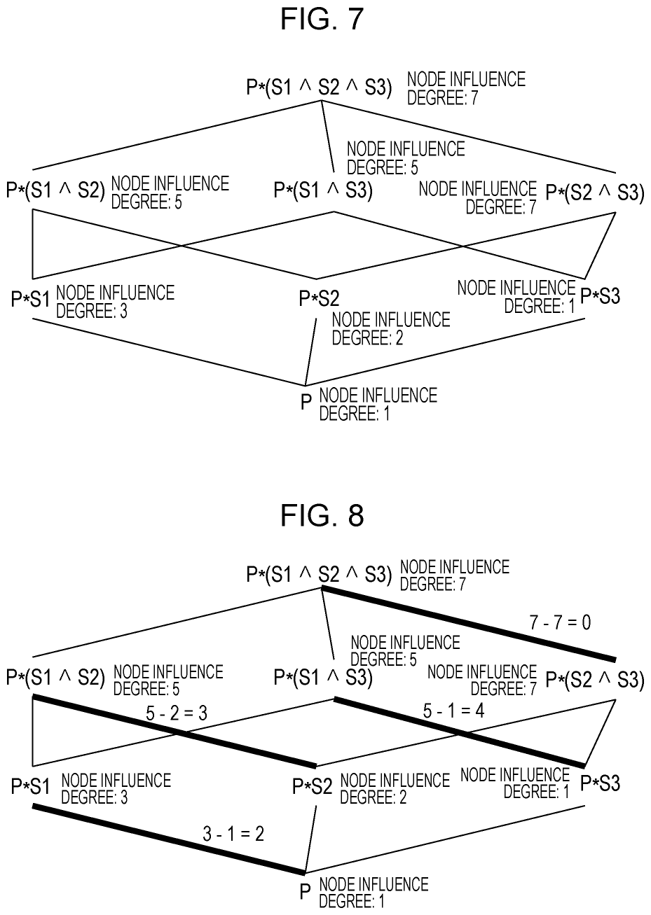

For each node constituted by the configuration section 22, the node calculation section 24 calculates a node influence degree representing the influence degree of the determination attribute included in the node on the label, as the degree of correlation of the determination attribute included in the node with the label, based on the influence degree function. FIG. 7 is a diagram illustrating an example of a case where a node influence degree is obtained for each node of a hierarchical structure. The node influence degree is an example of the degree of correlation.

An example of the influence degree function will be described. The influence degree function is expressed by the following equation (1), for example, when correlation of the ratio of the attribute to the label of the combination of the attributes is obtained.

$$C ( x ) = {max}_{l} \frac{n ( x , l )}{n ( x )} \qquad ( 1 )$$

Here, l represents a label, x represents a combination of values which a set of attributes may take, and n (⋅) represents the number of occurrences of data “⋅” in the entire data to be analyzed. The correlation of a set of R1∧S3 may be written as C (R1∧S3). The node influence degree is assumed to be a sum of the correlation of respective sets included in the node. The node influence degree of the node may be written as C (P*S3). A minimum value, a maximum value, or a median value of the influence degree of each set may be the node influence degree.

For each of noted determination attributes, the determination attribute calculation section 26 calculates the influence degree of the noted determination attribute based on a change amount in the node influence degree of the edge of the hierarchical structure. Specifically, a change amount in the influence degree obtained by subtracting the node influence degree of the node in a lower layer of the combination pattern not including the noted determination attribute from the node influence degree of the node of the combination pattern including the noted determination attribute is calculated. That is, the change amount in the node influence degree is calculated for each of noted edges. The noted edge is an edge coupling a node of a combination pattern including the noted determination attribute and a node of a lower layer of a combination pattern not including the noted determination attribute. By calculating the sum of the change amounts in the node influence degree on each of the noted edges for the noted determination attribute, the influence degree of the noted determination attribute on the label is calculated. The combination pattern including the noted determination attribute is an example of a first combination pattern. The combination pattern that does not include the noted determination attribute is an example of a second combination pattern.

FIG. 8 is a diagram illustrating an example of a method for calculating an influence degree of a determination attribute in a combination pattern. As illustrated in FIG. 8, when the noted determination attribute is S1, the edge coupling a node of P*(S1∧S2∧S3) to a node of P*(S2∧S3) becomes the noted edge. In this case, 7−7=0 obtained by subtracting the node influence degree 7 of P*(S1∧S2) from the node influence degree 7 of P* (S3∧S2∧S3) is calculated as the change amount of the, noted edge. Similarly, the change amount is calculated for the noted edge such as P*(S1∧S2) and P*S2. In a case of S1 illustrated in FIG. 8, it is possible to calculate the influence degree of S1 by the value of 0+4+3+2=9.

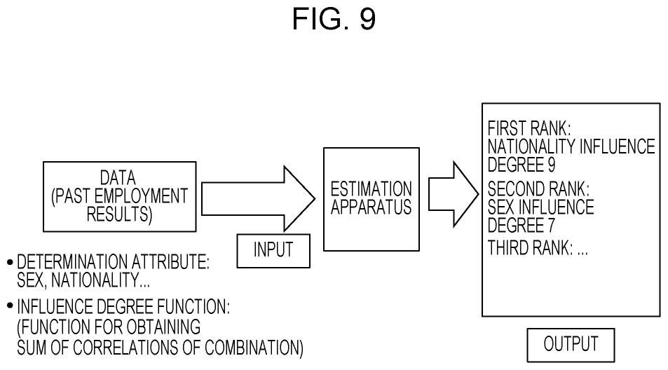

The rank calculation section 28 ranks the determination attribute based on the influence degree calculated for each of the determination attributes, and outputs the ranked determination attribute together with the influence degree. FIG. 9 is a diagram illustrating an example of an input/output image of the estimation apparatus 10. As illustrated in FIG. 9, when the data, the determination attribute, and the influence degree function are input, the estimation apparatus 10 performs processing of each processing section described above to output a rank of the determination attribute.

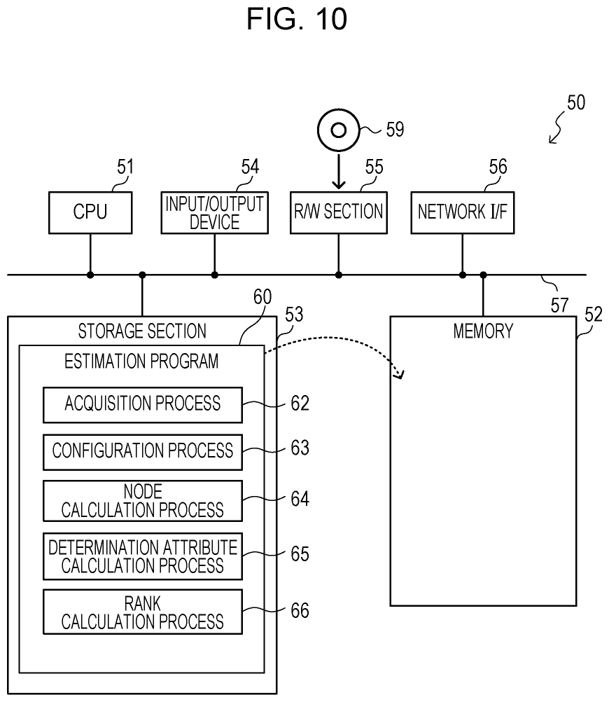

The estimation apparatus 10 may be realized by, for example, a computer 50 illustrated in FIG. 10. The computer 50 includes a central processing unit (CPU) 51, a memory 52 as a temporary storage area, and a nonvolatile storage section 53. The computer 50 also includes an input/output device 54, a read/write (R/W) section 55 for controlling reading and writing of data to and from a storage medium 59, and a communication interface (I/F) 56 coupled to a network such as the Internet. The CPU 51, the memory 52, the storage section 53, the input/output device 54, the R/W section 55, and the communication I/F 56 are coupled to one another via a bus 57.

The storage section 53 is able to be realized by a hard disk drive (HDD), a solid state drive (SSD), a flash memory, or the like. In the storage section 53 serving as a storage medium, an estimation program 60 that causes the computer 50 to function as the estimation apparatus 10 is stored. The estimation program 60 includes an acquisition process 62, a configuration process 63, a node calculation process 64, a determination attribute calculation process 65, and a rank calculation process 66.

The CPU 51 reads the estimation program 60 from the storage section 53, loads the read estimation program 60 into the memory 52, and sequentially executes the processes included in the estimation program 60. The CPU 51 operates as the acquisition section 20 illustrated in FIG. 5 when the acquisition process 62 is executed. The CPU 51 operates as the configuration section 22 illustrated in FIG. 5 when the configuration process 63 is executed. The CPU 51 operates as the node calculation section 24 illustrate in FIG. 5 when the node calculation process 64 is executed. The CPU 51 operates as the determination attribute calculation section 26 illustrated in FIG. 5 when the determination attribute calculation process 65 is executed. The CPU 51 operates as the rank calculation section 28 illustrated in FIG. 5 when the rank calculation process 66 is executed. Thus, the computer 50 executes the estimation program 60, thereby functioning as the estimation apparatus 10. The CPU 51 that executes the program is hardware. The CPU 51 may be referred to as a processor, but it is assumed that the processor does not include a software processor.

The functions realized by the estimation program 60 are also able to be realized by, for example, a semiconductor integrated circuit. Examples of the semiconductor integrated circuit include, for example, an application specific integrated circuit (ASIC),

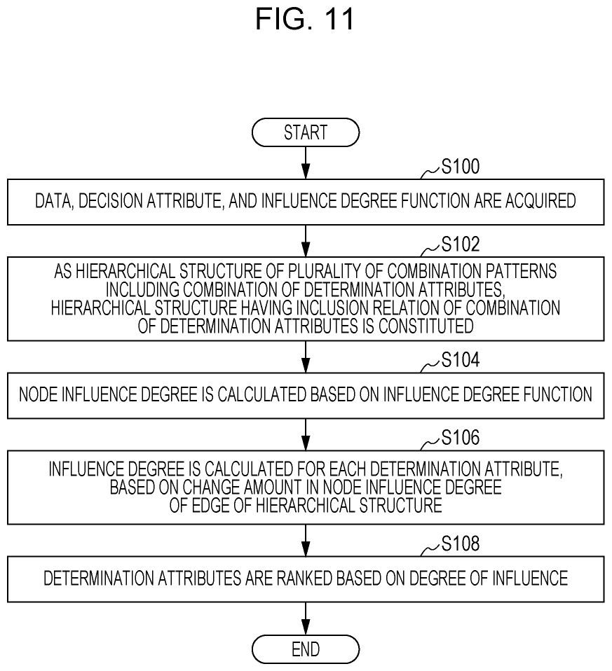

Next, operation of the estimation apparatus 10 according to the embodiment will be described with reference to a flowchart of FIG. 11.

In step S100, the acquisition section 20 acquires data including the attribute and the label as data to be analyzed, the determination attribute as a target among data, and an influence degree function used for the calculation of the node calculation section 24.

In step S102, the configuration section 22 constitutes, as a hierarchical structure of a plurality of combination patterns including a combination of determination attributes, a hierarchical structure in which assuming that the combination pattern is a node, an edge coupling each node to each other has an inclusion relation of a combination of determination attributes.

In step S104, for each node constituted by the configuration section 22, the node calculation section 24 calculates a node influence degree representing the influence degree of the determination attribute included in the node on the label, as the degree of correlation of the determination attribute included in the node with the label, based on the acquired function.

In step S106, for each of noted determination attributes, the determination attribute calculation section 26 calculates the influence degree of the noted determination attribute based on a change amount in the node influence degree of the edge of the hierarchical structure.

In step S108, the rank calculation section 28 ranks the determination attribute based on the influence degree calculated for each of the determination attributes, and outputs the ranked determination attribute together with the influence degree.

As described above, according to the estimation apparatus of the embodiment, for each node in the hierarchical structure, the node influence degree is calculated, and for each of noted determination attributes, the influence degree of the noted determination attribute is calculated based on a change amount in the node influence degree of the edge of the hierarchical structure. The determination attribute is ranked based on the influence degree calculated for each of the determination attributes. Therefore, it is possible to rank the attribute with grasping the correlation of the combination of attributes and considering the influence of other attributes.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium comprising a program which, when executed by a processor, cause the processor to:
estimate, with respect to a determination result of a determination model for performing determination based on a plurality of attribute values corresponding to a plurality of attributes related to a target, a degree of correlation of each of a plurality of combination patterns with the determination result, each combination pattern being a combination that includes one or more attributes selected from attributes satisfying a predetermined condition among the plurality of attributes and none or one or more attributes selected from attributes other than the attributes satisfying the predetermined condition among the plurality of attributes, and
estimate, based on a difference between a first degree of correlation of a first combination pattern among the plurality of combination patterns with the determination result and a second degree of correlation of a second combination pattern that is a combination pattern obtained by removing a first attribute among the attributes satisfying the predetermined condition from the first combination pattern with the determination result, a degree of influence of he first attribute on the determination result.

2. The non-transitory computer-readable recording medium of claim 1,
wherein the degree of correlation is estimated based on a ratio of the determination result to the combination pattern.

3. The non-transitory computer-readable recording medium of claim 1,
wherein in a case where a plurality of the first attributes are provided and a plurality of the first combination patterns are provided, a difference in the degree of correlation with the second combination pattern corresponding to each of the first combination patterns is obtained for the first attributes and the first attributes are ranked using a sum of the obtained differences in the degree of correlation as the degree of influence.

4. The non-transitory computer-readable recording medium of claim 3, wherein the processor is further configured to output the plurality of first attributes ranked according to the sum of the obtained differences in the degree of correlation as the degree of influence.

5. The non-transitory computer-readable recording medium of claim 1, wherein the degree of influence is calculated according to the following equation
$$C ( x ) = {max}_{l} \frac{n ( x , l )}{n ( x )} ,$$
l represents the determination result, x represents a combination of the plurality of attribute values, and n (⋅) represents the number of occurrences of data “⋅” in data analyzed b the determination model.

6. The non-transitory computer-readable recording medium of claim 1, wherein the processor is further cause to:
divide the plurality of attributes related to the target into a plurality of groups, a first group of the attributes satisfying a predetermined condition and a second group of the attributes other than the attributes satisfying the predetermined condition.

7. The non-transitory computer-readable medium of claim 1, wherein the determination model is a machine-learning model.

8. An estimation apparatus comprising:
a memory; and
a processor coupled to the memory and the processor configured to:
estimate, with respect to a determination result of a determination model for performing determination based on a plurality of attribute values corresponding to a plurality of attributes related to a target, a degree of correlation of each of a plurality of combination patterns with the determination result, each combination pattern being a combination that includes one or more attributes selected from attributes satisfying a predetermined condition among the plurality of attributes and none or one or more attributes selected from attributes other than the attributes satisfying the predetermined condition among the plurality of attributes, and
estimate, based on a difference between a first degree of correlation of first combination pattern among the plurality of combination patterns with the determination result and a second degree of correlation of a second combination pattern that is a combination pattern obtained by removing a first attribute among the attributes satisfying the predetermined condition from the first combination pattern with the determination result, a degree of influence of the first attribute on the determination result.

9. The estimation apparatus of claim 8,
wherein the degree of correlation is estimated based on a ratio of the determination result to the combination pattern.

10. The estimation apparatus of claim 8,
wherein in a case where a plurality of the first attributes are provided and a plurality of the first combination patterns are provided, a difference in the degree of correlation with the second combination pattern corresponding to each of the first combination patterns is obtained for the first attributes and the first attributes are ranked using a sum of the obtained differences in the degree of correlation as the degree of influence.

11. The estimation apparatus according to claim 10, wherein the processor is further configured to output the plurality of first attributes ranked according to the sum of the obtained differences in the degree of correlation as the degree of influence.

12. The estimation apparatus of claim 8, wherein the degree of influence is calculated according to the following equation
$$C ( x ) = {max}_{l} \frac{n ( x , l )}{n ( x )} ,$$
l represents the determination result, x represents a combination of the plurality of attribute values, and n (⋅) represents the number of occurrences of data “⋅” in data analyzed by the determination model.

13. The estimation apparatus of claim 8, wherein the processor is further cause to:
divide the plurality of attributes related to the target into a plurality of groups, a first group of the attributes satisfying a predetermined condition and a second group of the attributes other than the attributes satisfying the predetermined condition.

14. The estimation apparatus of claim 8, wherein the determination model is a machine-learning model.

15. A computer-implemented estimation method comprising:
estimating, with respect to a determination result of a determination model for performing determination based on a plurality of attribute values corresponding to a plurality of attributes related to a target, a degree of correlation of each of a plurality of combination patterns with the determination result, each combination pattern being combination that includes one or more attributes selected from attributes satisfying a predetermined condition among the plurality of attributes and none or one or more attributes selected from attributes other than the attributes satisfying the predetermined condition among the plurality of attributes, and
estimating, based on a difference between a first degree of correlation of a first combination pattern among the plurality of combination patterns with the determination result and a second degree of correlation of a second combination pattern that is a combination pattern obtained by removing a first attribute among the attributes satisfying the predetermined condition from the first combination pattern with the determination result, a degree of influence of the first attribute on the determination result.

16. The computer-implemented estimation method of claim 15,
wherein the degree of correlation is estimated based on a ratio of the determination result to the combination pattern.

17. The computer-implemented estimation method of claim 15,
wherein in a case where a plurality of the first attributes are provided and a plurality of the first combination patterns are provided, a difference in the degree of correlation with the second combination pattern corresponding to each of the first combination patterns is obtained for the first attributes and the first attributes are ranked using a sum of the obtained differences in the degree of correlation as the degree of influence.

18. The computer-implemented estimation method of claim 15, wherein the degree of influence is calculated according to the following equation
$$C ( x ) = {max}_{l} \frac{n ( x , l )}{n ( x )} ,$$
l represents the determination result, x represents a combination of the plurality of attribute values, and n (⋅) represents the number of occurrences of data “⋅” in data analyzed by the determination model.

19. The computer-implemented estimation method of claim 15, wherein the processor is further cause to:
divide the plurality of attributes related to the target into a plurality of groups, a first group of the attributes satisfying a predetermined condition and a second group of the attributes other than the attributes satisfying the predetermined condition.

20. The computer-implemented estimation method of claim 15, wherein the determination model is a machine-learning model.
